(19) United States
(12) Patent Application Publication
(10) Pub. No.: US 2022/0127932 A1
(43) Pub. Date: Apr. 28, 2022

(54) Monitoring Equipment of a Plurality of Drill Rigs

(71) Applicant: Schlumberger Technology Corporation, Sugar Land, TX (US)

(72) Inventor: Juan-Carlos Yepez, Katy, TX (US)

(21) Appl. No.: 17/078,338

(22) Filed: Oct. 23, 2020

(51) Int. Cl. E21B 41/00; G01B 21/18; E21B 45/00; E21B 47/04; E21B 3/02; E21B 19/00

(52) U.S. Cl. CPC E21B 41/00; G01B 21/18; E21B 19/008; E21B 47/04; E21B 3/022; E21B 45/00

(57) ABSTRACT

Systems and methods for monitoring equipment of multiple drill rigs. Each drill rig comprises multiple equipment units collectively operable to perform well construction operations to construct a well. An example monitoring system may be operable to receive operational data from each drill rig, determine operational status of each drill rig based at least partially on the operational data, and determine operational health indicators for each equipment unit of each drill rig based at least partially on the operational data. Each operational health indicator is indicative of operational health of a corresponding equipment unit with respect to a different operational health category. The monitoring system may be further operable to display the operational status for each drill rig, including the operational health indicators for each equipment unit of each drill rig, as a single page on a video output device.

### BACKGROUND OF THE DISCLOSURE

Wells are generally drilled into the ground or ocean bed to recover natural deposits of oil, gas, and other materials that are trapped in subterranean formations. Well construction operations (e.g., drilling operations) may be performed at a wellsite by a well construction system (i.e., a drill rig) having various automated surface and subterranean well construction equipment operating in a coordinated manner. For example, a drive mechanism, such as a top drive or a rotary table located at a wellsite surface, may be utilized to rotate and advance a drill string into a subterranean formation to drill a wellbore. The drill string may include a plurality of drill pipes coupled together and terminating with a drill bit. The length of the drill string is increased by adding additional drill pipes as the depth of the wellbore increases. A drilling fluid (i.e., drilling mud) may be pumped by mud pumps from the wellsite surface down through the drill string to the drill bit. The drilling fluid lubricates and cools the drill bit, and carries drill cuttings from the wellbore back to the wellsite surface. The drilling fluid returning to the surface may then be cleaned and again pumped through the drill string.

The success of well construction operations may be related to many factors, including failure rates. Due to high pressures, high forces, and high frequency of use, certain pieces of well construction equipment can wear out and fail. Equipment wear and impending failures are often detected late, resulting in operational stoppages and severe damage to the equipment. Operational interruptions may reduce efficiency of the well construction operations and delay completion of the well. Such consequences make equipment health diagnosis, preemptive equipment maintenance, and timely detection of failures a high priority in the oil and gas industry.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a monitoring system for monitoring multiple drill rigs. Each drill rig includes multiple equipment units collectively operable to perform well construction operations to construct a well. The monitoring system includes a processor and a memory storing an executable computer program code. The monitoring system is operable to receive operational data from each of the drill rigs and determine operational status of each drill rig based at least partially on the operational data. The monitoring system is also operable to determine operational health indicators for each equipment unit of each drill rig based at least partially on the operational data. Each operational health indicator is indicative of operational health of a corresponding equipment unit with respect to a different operational health category. The monitoring system is also operable to display the operational status for each drill rig and the operational health indicators for each equipment unit of each drill rig on a single page on a video output device.

The present disclosure also introduces a monitoring system for monitoring multiple drill rigs, where each drill rig includes equipment units collectively operable to perform well construction operations to construct a well, and where the monitoring system includes a processor and a memory storing an executable computer program code. The monitoring system is operable to receive operational data from each of the drill rigs and determine operational health indicators for each equipment unit of each drill rig based at least partially on the operational data. A first one of the operational health indicators is indicative of an active status of a corresponding equipment unit. A second one of the operational health indicators is indicative of operational health of a corresponding equipment unit with respect to a threshold of normal operation of that equipment unit. The monitoring system is also operable to display the operational health indicators for each equipment unit of each drill rig on a single page on a video output device.

The present disclosure also introduces a method that includes commencing operation of a monitoring system for monitoring multiple drill rigs. Each drill rig includes equipment units collectively operable to perform well construction operations to construct a well. Commencing operation of the monitoring system causes the monitoring system to receive operational data from each of the drill rigs and determine operational status of each drill rig based at least partially on the operational data. Commencing operation of the monitoring system also causes the monitoring system to determine operational health indicators for each equipment unit of each drill rig based at least partially on the operational data. Each operational health indicator is indicative of operational health of a corresponding equipment unit with respect to a different operational health category. Commencing operation of the monitoring system also causes the monitoring system to display the operational status for each drill rig and the operational health indicators for each equipment unit of each drill rig on a single page on a video output device.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic side view of at least a portion of an example implementation of apparatus according to one or more aspects of the present disclosure.

FIG. 2 is a schematic view of at least a portion of an example implementation of apparatus according to one or more aspects of the present disclosure.

FIGS. 3-7 are example implementations of screens displayed by the apparatus shown in FIGS. 1 and 2 according to one or more aspects of the present disclosure.

FIG. 8 is a schematic view of at least a portion of an example implementation of apparatus according to one or more aspects of the present disclosure.

### DETAILED DESCRIPTION

It is to be understood that the following disclosure describes many example implementations for different aspects introduced herein. Specific examples of components and arrangements are described below to simplify the present disclosure. These are merely examples, and are not intended to be limiting. In addition, the present disclosure may repeat reference numerals and/or letters in the various examples. This repetition is for simplicity and clarity, and does not in itself dictate a relationship between the various implementations described herein. Moreover, the formation of a first feature over or on a second feature in the description that follows may include implementations in which the first and second features are formed in direct contact, and may also include implementations in which additional features may be formed interposing the first and second features, such that the first and second features may not be in direct contact.

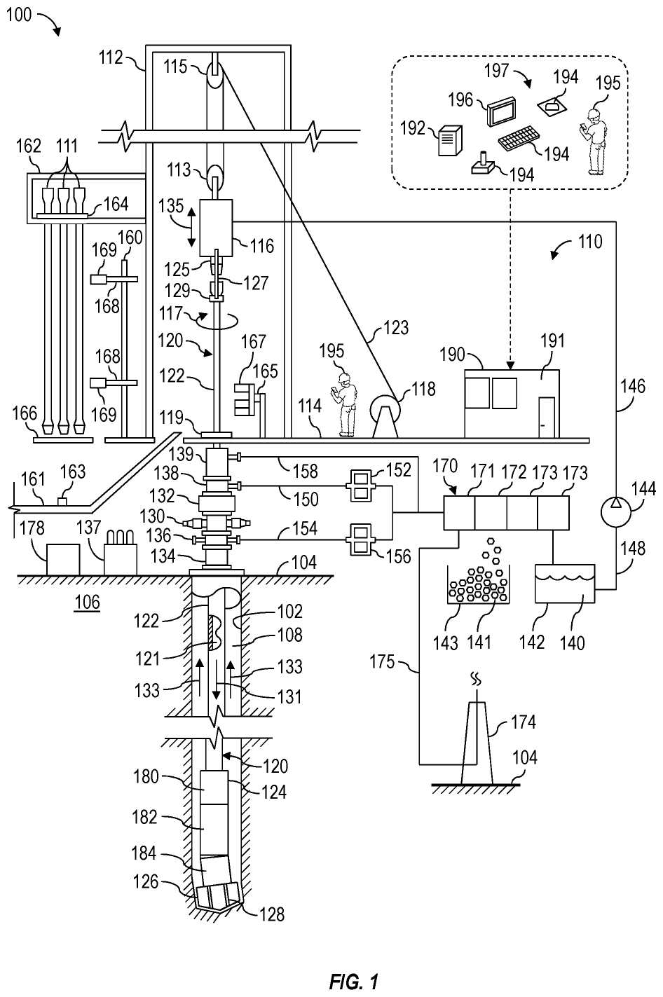

FIG. 1 is a schematic view of at least a portion of an example implementation of a well construction system 100 according to one or more aspects of the present disclosure. The well construction system 100 represents an example environment in which one or more aspects of the present disclosure described below may be implemented. The well construction system 100 may be or comprise a drilling rig and associated well construction equipment collectively operable to construct (e.g., drill) a wellbore 102 extending from a wellsite surface 104 into a subterranean formation 106 via rotary and/or directional drilling. During drilling operations, the various well construction equipment of the well construction system 100 may progress through a plurality of coordinated well construction operations (i.e., operational sequences) to drill or otherwise construct the wellbore 102. Although the well construction system 100 is depicted as an onshore implementation, the aspects described below are also applicable or readily adaptable to offshore implementations.

The well construction system 100 comprises various well construction equipment, including surface equipment 110 located at the wellsite surface 104 and a drill string 120 suspended within the wellbore 102. The surface equipment 110 may include a mast, a derrick, and/or another support structure 112 disposed over a rig floor 114. The drill string 120 may be suspended within the wellbore 102 from the support structure 112. The support structure 112 and the rig floor 114 are collectively supported over the wellbore 102 by legs and/or other support structures (not shown).

The drill string 120 may comprise a bottom-hole assembly (BHA) 124 and means 122 for conveying the BHA 124 within the wellbore 102. The conveyance means 122 may comprise a plurality of interconnected tubulars, such as drill pipe, heavy-weight drill pipe (HWDP), wired drill pipe (WDP), tough logging condition (TLC) pipe, and drill collars, among other examples. The conveyance means 122 may instead comprise coiled tubing for conveying the BHA 124 within the wellbore 102. A downhole end of the BHA 124 may include or be coupled to a drill bit 126. Rotation of the drill bit 126 and the weight of the drill string 120 collectively operate to form the wellbore 102. The drill bit 126 may be rotated from the wellsite surface 104 and/or via a downhole mud motor 184 connected with the drill bit 126. The BHA 124 may also include various downhole devices and/or tools 180, 182.

The support structure 112 may support a driver, such as a top drive 116, operable to connect (perhaps indirectly) with an upper end of the drill string 120, and to impart rotary motion 117 and vertical motion 135 to the drill string 120, including the drill bit 126. However, another driver, such as a kelly and rotary table (neither shown), may be utilized instead of or in addition to the top drive 116 to impart the rotary motion 117 to the drill string 120. The top drive 116 and the connected drill string 120 may be suspended from the support structure 112 via a hoisting system or equipment, which may include a traveling block 113, a crown block 115, and a drawworks 118 storing a support cable or line 123. The crown block 115 may be connected to or otherwise supported by the support structure 112, and the traveling block 113 may be coupled with the top drive 116. The drawworks 118 may be mounted on or otherwise supported by the rig floor 114. The crown block 115 and traveling block 113 comprise pulleys or sheaves around which the support line 123 is reeved to operatively connect the crown block 115, the traveling block 113, and the drawworks 118. The drawworks 118 may thus selectively impart tension to the support line 123 to lift and lower the top drive 116, resulting in the vertical motion 135. The drawworks 118 may comprise a drum, a base, and a prime mover (e.g., an electric motor) (not shown) operable to drive the drum to rotate and reel in the support line 123, causing the traveling block 113 and the top drive 116 to move upward. The drawworks 118 may be operable to reel out the support line 123 via a controlled rotation of the drum, causing the traveling block 113 and the top drive 116 to move downward.

The top drive 116 may comprise a grabber, a swivel (neither shown), elevator links 127 terminating with an elevator 129, and a drive shaft 125 operatively connected with a prime mover (e.g., an electric motor) (not shown). The drive shaft 125 may be selectively coupled with the upper end of the drill string 120 and the prime mover may be selectively operated to rotate the drive shaft 125 and the drill string 120 coupled with the drive shaft 125. Hence, during drilling operations, the top drive 116, in conjunction with operation of the drawworks 118, may advance the drill string 120 into the formation 106 to form the wellbore 102. The elevator links 127 and the elevator 129 of the top drive 116 may handle tubulars (e.g., drill pipes, drill collars, casing joints, etc.) that are not mechanically coupled to the drive shaft 125. For example, when the drill string 120 is being tripped into or out of the wellbore 102, the elevator 129 may grasp the tubulars of the drill string 120 such that the tubulars may be raised and/or lowered via the hoisting equipment mechanically coupled to the top drive 116. The grabber may include a clamp that clamps onto a tubular when making up and/or breaking out a connection of a tubular with the drive shaft 125. The top drive 116 may have a guide system (not shown), such as rollers that track up and down a guide rail on the support structure 112. The guide system may aid in keeping the top drive 116 aligned with the wellbore 102, and in preventing the top drive 116 from rotating during drilling by transferring reactive torque to the support structure 112.

The drill string 120 may be conveyed within the wellbore 102 through various fluid control devices disposed at the wellsite surface 104 on top of the wellbore 102 and perhaps below the rig floor 114. The fluid control devices may be operable to control fluid within the wellbore 102. The fluid control devices may include a blowout preventer (BOP) stack 130 for maintaining well pressure control comprising a series of pressure barriers (e.g., rams) between the wellbore 102 and an annular preventer 132. The fluid control devices may also include a rotating control device (RCD) 138 mounted above the annular preventer 132. The fluid control devices 130, 132, 138 may be mounted on top of a wellhead 134. A power unit 137 (i.e., a BOP control or closing unit) may be operatively connected with one or more of the fluid control devices 130, 132, 138 and operable to actuate, drive, operate, or otherwise control one or more of the fluid control devices 130, 132, 138. The power unit 137 may be or comprise a hydraulic fluid power unit fluidly connected with the fluid control devices 130, 132, 138 and selectively operable to hydraulically drive various portions (e.g., rams, valves, seals, etc.) of the fluid control devices 130, 132, 138. The power unit 137 may comprise one or more hydraulic pumps actuated by electric motors and operable to pressurize hydraulic fluid for operating the fluid control devices 130, 132, 138, as described herein.

The well construction system 100 may further include a drilling fluid circulation system or equipment operable to circulate fluids between the surface equipment 110 and the drill bit 126 during drilling and other operations. For example, the drilling fluid circulation system may be operable to inject a drilling fluid from the wellsite surface 104 into the wellbore 102 via an internal fluid passage 121 extending longitudinally through the drill string 120. The drilling fluid circulation system may comprise a pit, a tank, and/or other fluid container 142 holding the drilling fluid 140 (i.e., drilling mud), and one or more mud pump units 144 operable to move the drilling fluid 140 from the container 142 into the fluid passage 121 of the drill string 120 via a fluid conduit 146 extending from the pump units 144 to the top drive 116 and an internal passage extending through the top drive 116. Each pump unit 144 may comprise a fluid pump (not shown) operable to pump the drilling fluid 140 and a prime mover (e.g., an electric motor) (not shown) operable to drive the corresponding fluid pump. The fluid conduit 146 may comprise one or more of a pump discharge line, a stand pipe, a rotary hose, and a gooseneck connected with a fluid inlet of the top drive 116. The pumps 144 and the container 142 may be fluidly connected by a fluid conduit 148, such as a suction line.

During drilling operations, the drilling fluid may continue to flow downhole through the internal passage 121 of the drill string 120, as indicated by directional arrow 131. The drilling fluid may exit the BHA 124 via ports 128 in the drill bit 126 and then circulate uphole through an annular space 108 of the wellbore 102 defined between an exterior of the drill string 120 and the wall of the wellbore 102, such flow being indicated by directional arrows 133. In this manner, the drilling fluid lubricates the drill bit 126 and carries formation cuttings uphole to the wellsite surface 104. The returning drilling fluid may exit the annular space 108 via different fluid control devices during different stages or scenarios of well drilling operations. For example, the drilling fluid may exit the annular space 108 via a bell nipple 139, the RCD 138, or a ported adapter 136 (e.g., a spool, cross adapter, a wing valve, etc.) located above one or more rams of the BOP stack 130.

During normal drilling operations, the drilling fluid may exit the annular space 108 via the bell nipple 139 and then be directed toward drilling fluid reconditioning equipment 170 via a fluid conduit 158 (e.g., a gravity return line) to be cleaned and/or reconditioned, as described below, before being returned to the container 142 for recirculation. During managed pressure drilling operations, the drilling fluid may exit the annular space 108 via the RCD 138 and then be directed into a choke manifold 152 (e.g., a managed pressure drilling choke manifold) via a fluid conduit 150 (e.g., a drilling pressure control line). The choke manifold 152 may include at least one choke and a plurality of fluid valves (neither shown) collectively operable to control the flow through and out of the choke manifold 152. Backpressure may be applied to the annular space 108 by variably restricting flow of the drilling fluid or other fluids flowing through the choke manifold 152. The greater the restriction to flow through the choke manifold 152, the greater the backpressure applied to the annular space 108. The drilling fluid exiting the choke manifold 152 may then pass through the drilling fluid reconditioning equipment 170 before being returned to the container 142 for recirculation. During well pressure control operations, such as when one or more rams of the BOP stack 130 is closed, the drilling fluid may exit the annular space 108 via the ported adapter 136 and be directed into a choke manifold 156 (e.g., a rig choke manifold or a well control choke manifold) via a fluid conduit 154 (e.g., a rig choke line). The choke manifold 156 may include at least one choke and a plurality of fluid valves (neither shown) collectively operable to control the flow of the drilling fluid through the choke manifold 156. Backpressure may be applied to the annular space 108 by variably restricting flow of the drilling fluid (and other fluids) flowing through the choke manifold 156. The drilling fluid exiting the choke manifold 156 may then pass through the drilling fluid reconditioning equipment 170 before being returned to the container 142 for recirculation.

Before being returned to the container 142, the drilling fluid returning to the wellsite surface 104 may be cleaned and/or reconditioned via the drilling fluid reconditioning equipment 170, which may include one or more of liquid gas (i.e., mud gas) separators 171, shale shakers 172, and other drilling fluid cleaning and reconditioning equipment 173. The liquid gas separators 171 may remove formation gases entrained in the drilling fluid discharged from the wellbore 102 and the shale shakers 172 may separate and remove solid particles 141 (e.g., drill cuttings) from the drilling fluid. The drilling fluid reconditioning equipment 170 may further comprise other equipment 173 operable to remove additional gas and finer formation cuttings from the drilling fluid and/or modify chemical and/or physical properties or characteristics (e.g., rheology, density, etc.) of the drilling fluid. For example, the drilling fluid reconditioning equipment 170 may include a degasser, a desander, a desilter, a centrifuge, a mud cleaner, and/or a decanter, among other examples. The drilling fluid reconditioning equipment 170 may further include chemical containers and mixing equipment collectively operable to mix or otherwise add selected chemicals to the drilling fluid returning from the wellbore 102 to modify chemical and/or physical properties or characteristics of the drilling fluid being pumped back into the wellbore 102. Intermediate tanks/containers (not shown) may be utilized to hold the drilling fluid while the drilling fluid progresses through the various stages or portions 171, 172, 173 of the drilling fluid reconditioning equipment 170. The cleaned and reconditioned drilling fluid may be transferred to the fluid container 142, the solid particles 141 removed from the drilling fluid may be transferred to a solids container 143 (e.g., a reserve pit), and/or the removed gas may be transferred to a flare stack 174 via a conduit 175 (e.g., a flare line) to be burned or to a container (not shown) for storage and removal from the wellsite.

The surface equipment 110 may include a tubular handling system or equipment operable to store, move, connect, and disconnect tubulars (e.g., drill pipes) to assemble and disassemble the conveyance means 122 of the drill string 120 during drilling operations. For example, a catwalk 161 may be utilized to convey tubulars from a ground level, such as along the wellsite surface 104, to the rig floor 114, permitting the elevator 129 to grab and lift the tubulars above the wellbore 102 for connection with previously deployed tubulars. The catwalk 161 may have a horizontal portion and an inclined portion that extends between the horizontal portion and the rig floor 114. The catwalk 161 may comprise a skate 163 movable along a groove (not shown) extending longitudinally along the horizontal and inclined portions of the catwalk 161. The skate 163 may be operable to convey (e.g., push) the tubulars along the catwalk 161 to the rig floor 114. The skate 163 may be driven along the groove by a drive system (not shown), such as a pulley system or a hydraulic system. Additionally, one or more racks (not shown) may adjoin the horizontal portion of the catwalk 161. The racks may have a spinner unit for transferring tubulars to the groove of the catwalk 161. The tubular handling system may comprise a plurality of actuators collectively operable to move various portions of the tubular handling equipment to perform the methods and operations described herein. The actuators may be or comprise electric motors and/or hydraulic cylinders and rotary actuators. The hydraulic cylinders and rotary actuators may be powered by hydraulic power packs comprising hydraulic pumps actuated by electric motors to pressurize hydraulic fluid.

Power tongs 165 (e.g., an iron roughneck) may be positioned at the rig floor 114. The power tongs 165 may comprise a torqueing portion 167, such as may include a spinner and a torque wrench comprising a lower tong and an upper tong. The torqueing portion 167 of the power tongs 165 may be moveable toward and at least partially around the drill string 120, such as may permit the power tongs 165 to make up and break out connections of the drill string 120. The power tongs 165 may also be moveable away from the drill string 120, such as may permit the power tongs 165 to move clear of the drill string 120 during drilling operations. The spinner of the power tongs 165 may be utilized to apply low torque to make up and break out threaded connections between tubulars of the drill string 120, and the torque wrench may be utilized to apply a higher torque to tighten and loosen the threaded connections. The power tongs 165 may comprise a plurality of actuators collectively operable to actuate the torqueing portion 167. The actuators may be or comprise electric motors.

A set of slips 119 may be located on the rig floor 114, such as may accommodate therethrough the drill string 120 during tubular make up and break out operations and during the drilling operations. The slips 119 may be in an open position during drilling operations to permit advancement of the drill string 120, and in a closed position to clamp the upper end (i.e., the uppermost tubular) of the drill string 120 to thereby suspend and prevent advancement of the drill string 120 within the wellbore 102, such as during the make up and break out operations.

During drilling operations, the hoisting system lowers the drill string 120 while the top drive 116 rotates the drill string 120 to advance the drill string 120 downward within the wellbore 102 and into the formation 106. During the advancement of the drill string 120, the slips 119 are in an open position, and the power tongs 165 is moved away or is otherwise clear of the drill string 120. When the upper end of the drill string 120 (i.e., upper end of the uppermost tubular of the drill string 120) connected to the drive shaft 125 is near the slips 119 and/or the rig floor 114, the top drive 116 ceases rotating and the slips 119 close to clamp the upper end of the drill string 120. The grabber of the top drive 116 then clamps the uppermost tubular connected to the drive shaft 125, and the drive shaft 125 rotates in a direction reverse from the drilling rotation to break out the connection between the drive shaft 125 and the uppermost tubular. The grabber of the top drive 116 may then release the uppermost tubular.

Multiple tubulars may be loaded on the rack of the catwalk 161 and individual tubulars may be transferred from the rack to the groove in the catwalk 161, such as by the spinner unit. The tubular positioned in the groove may be conveyed along the groove by the skate 163 until the box end of the tubular projects above the rig floor 114. The elevator 129 of the top drive 116 then grasps the protruding box end, and the drawworks 118 may be operated to lift the top drive 116, the elevator 129, and the new tubular.

The hoisting system then raises the top drive 116, the elevator 129, and the new tubular until the tubular is aligned with the upper portion of the drill string 120 clamped by the slips 119. The power tongs 165 is moved toward the drill string 120, and the lower tong of the torqueing portion 167 clamps onto the upper end of the drill string 120. The spinning system threadedly connects the lower end (i.e., pin end) of the new tubular with the upper end (i.e., box end) of the drill string 120. The upper tong then clamps onto the new tubular and rotates with high torque to complete making up the connection with the drill string 120. In this manner, the new tubular becomes part of the drill string 120. The power tongs 165 then releases and moves clear of the drill string 120.

The grabber of the top drive 116 may then clamp onto the drill string 120. The drive shaft 125 is brought into contact with the upper end of the drill string 120 (i.e., the box end of the uppermost tubular) and rotated to make up a connection between the drill string 120 and the drive shaft 125. The grabber then releases the drill string 120, and the slips 119 are moved to the open position. The drilling operations may then resume.

The tubular handling equipment may further include a tubular handling manipulator (THM) 160 disposed in association with a vertical pipe rack 162 for storing tubulars 111 (e.g., drill pipes, drill collars, drill pipe stands, casing joints, etc.). The vertical pipe rack 162 may comprise or support a fingerboard 164 defining a plurality of slots configured to support or otherwise hold the tubulars 111 within or above a setback 166 (e.g., a platform or another area) located adjacent to, along, or below the rig floor 114. The fingerboard 164 may comprise a plurality of fingers (not shown), each associated with a corresponding slot and operable to close around and/or otherwise interpose individual tubulars 111 to maintain the tubulars 111 within corresponding slots of the fingerboard 164. The vertical pipe rack 162 may be connected with and supported by the support structure 112 or another portion of the wellsite system 100. The fingerboard 164/setback 166 provide storage (e.g., a temporary storage) of tubulars 111 during various operations, such as during and between tripping out and tripping of the drill string 120. The THM 160 may comprise a plurality of actuators collectively operable to move various portions of the THM 160 to perform the methods and operations described herein. The actuators may be or comprise electric motors.

The THM 160 may be operable to transfer the tubulars 111 between the fingerboard 164/setback 166 and the drill string 120 (i.e., space above the suspended drill string 120). For example, the THM 160 may include arms 168 terminating with clamps 169, such as may be operable to grasp and/or clamp onto one of the tubulars 111. The arms 168 of the THM 160 may extend and retract, and/or at least a portion of the THM 160 may be rotatable and/or movable toward and away from the drill string 120, such as may permit the THM 160 to transfer the tubular 111 between the fingerboard 164/setback 166 and the drill string 120.

To trip out the drill string 120, the top drive 116 is raised, the slips 119 are closed around the drill string 120, and the elevator 129 is closed around the drill string 120. The grabber of the top drive 116 clamps the upper end of a tubular of the drill string 120 coupled to the drive shaft 125. The drive shaft 125 then rotates in a direction reverse from the drilling rotation to break out the connection between the drive shaft 125 and the drill string 120. The grabber of the top drive 116 then releases the tubular of the drill string 120, and the drill string 120 is suspended by (at least in part) the elevator 129. The power tongs 165 is moved toward the drill string 120. The lower tong clamps onto a lower tubular below a connection of the drill string 120, and the upper tong clamps onto an upper tubular above that connection. The upper tong then rotates the upper tubular to provide a high torque to break out the connection between the upper and lower tubulars. The spinning system then rotates the upper tubular to separate the upper and lower tubulars, such that the upper tubular is suspended above the rig floor 114 by the elevator 129. The power tongs 165 then releases the drill string 120 and moves clear of the drill string 120.

The THM 160 may then move toward the drill string 120 to grasp the tubular suspended from the elevator 129. The elevator 129 then opens to release the tubular. The THM 160 then moves away from the drill string 120 while grasping the tubular with the clamps 169, places the tubular in the fingerboard 164/setback 166, and releases the tubular for storage. This process is repeated until the intended length of drill string 120 is removed from the wellbore 102.

The well construction system 100 may further comprise a power supply system 178 configured to supply electrical and mechanical (e.g., fluid) power for actuating or otherwise powering the surface equipment 110. The power supply system 178 may include one or more electric generators, electrical energy storage devices (e.g., batteries, capacitors, etc.), and fuel storage devices, among other examples. The power supply system 178 may also include various means (not shown) for transferring and/or distributing electrical power, mechanical power, and fuel to the well construction equipment and between various equipment of the power supply system 178, including electrical power conductors, electrical connectors, electrical relays, fluid conductors, fluid connectors, and fluid valves, among other examples.

The surface equipment 110 of the well construction system 100 may also comprise a control center 190 from which various portions of the well construction system 100, such as the top drive 116, the hoisting system, the tubular handling system, the drilling fluid circulation system, the well control system, the BHA 124, among other examples, may be monitored and controlled. The control center 190 may be located on the rig floor 114 or another location of the well construction system 100. The control center 190 may comprise a facility 191 (e.g., a room, a cabin, a trailer, etc.) containing a control workstation 197, which may be operated by rig personnel 195 (e.g., a driller or another human rig operator) to monitor and control various well construction equipment or portions of the well construction system 100. The control workstation 197 may comprise or be communicatively connected with a central controller 192 (e.g., a processing device, a computer, etc.), such as may be operable to receive, process, and output information to monitor operations of and provide control to one or more portions of the well construction system 100. For example, the central controller 192 may be communicatively connected with the various surface equipment 110 and downhole equipment 120 described herein, and may be operable to receive signals from and transmit signals to such equipment to perform various operations described herein. The central controller 192 may store executable computer program code, instructions, and/or operational parameters or set-points, including for implementing one or more aspects of methods and operations described herein. The central controller 192 may be located within and/or outside of the facility 191. Although it is possible that the entirety of the central controller 192 is implemented within one device, it is also contemplated that one or more components or functions of the central controller 192 may be implemented across multiple devices, some or an entirety of which may be implemented as part of the control center 190 and/or located within the facility 191.

The control workstation 197 may be operable for entering or otherwise communicating control data (e.g., commands, signals, information, etc.) to the central controller 192 and other equipment controller by the rig personnel 195, and for displaying or otherwise communicating information from the central controller 192 to the rig personnel 195. The control workstation 197 may comprise one or more input devices 194 (e.g., a keyboard, a mouse, a joystick, a touchscreen, etc.) and one or more output devices 196 (e.g., a video monitor, a touchscreen, a printer, audio speakers, etc.). Communication between the central controller 192, the input and output devices 194, 196, and the various well construction equipment may be via wired and/or wireless communication means. However, for clarity and ease of understanding, such communication means are not depicted, and a person having ordinary skill in the art will appreciate that such communication means are within the scope of the present disclosure.

Other implementations of the well construction system 100 within the scope of the present disclosure may include more or fewer components than as described above and/or depicted in FIG. 1. Additionally, the various well construction equipment and/or subsystems of the well construction system 100 shown in FIG. 1 may include more or fewer components than as described above and depicted in FIG. 1. For example, various engines, motors, hydraulics, actuators, valves, and/or other components not explicitly described herein may be included in the well construction system 100, and are within the scope of the present disclosure.

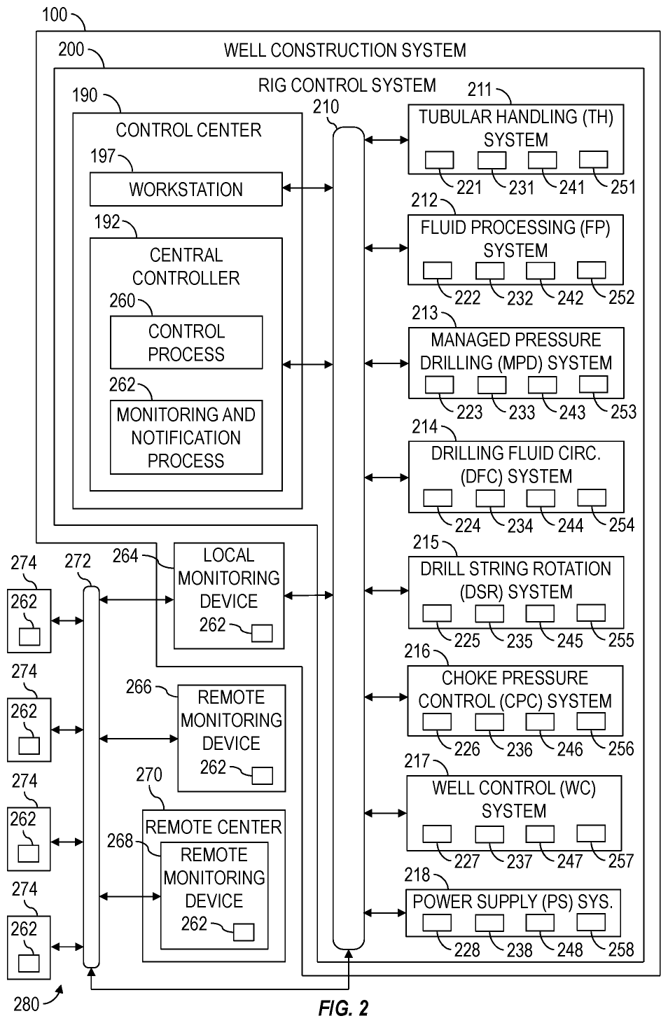

The present disclosure is further directed to various implementations of systems and/or methods for monitoring and controlling one or more portions of the well construction system 100. FIG. 2 is a schematic view of at least a portion of an example implementation of a drilling rig monitoring and control system 200 (hereinafter a “rig control system”) for monitoring and controlling various well construction equipment of the well construction system 100 shown in FIG. 1. The rig control system 200 may comprise one or more features of the well construction system 100, including where indicated by the same reference numerals. Accordingly, the following description refers to FIGS. 1 and 2, collectively.

The rig control system 200 may comprise a central controller 192 and a plurality of local controllers collectively operable to monitor and/or control, various portions, components, and equipment of the well construction system 100. The rig control system 200 may further comprise a control workstation 197, which may be operated by rig personnel 195 to monitor and/or control, various portions, components, and equipment of the well construction system 100. The equipment of the well construction system 100 may be grouped into several subsystems, each operable to perform a corresponding operation and/or a portion of the well construction operations described herein. The subsystems may include a tubular handling (TH) system 211, a fluid processing (FP) system 212, a managed pressure drilling (MPD) system 213, a drilling fluid circulation (DFC) system 214, a drill string rotation system (DSR) system 215, a choke pressure control (CPC) system 216, a well pressure control (WC) system 217, and a power supply (PS) system 218.

The TH system 211 may include the support structure 112, a tubular hoisting system (e.g., the drawworks 118, the elevator links 127, the elevator 129, the slips 119), a tubular handling system or equipment (e.g., the catwalk 161, the THM 160, the setback 166, and/or the power tongs 165), and/or other tubular handling equipment. Accordingly, the TH system 211 may perform tubular handling and hoisting operations. The TH system 211 may also serve as a support platform for tubular rotation equipment and staging ground for rig operations, such as connection make up and break out operations described above. The FP system 212 may include the drilling fluid reconditioning equipment 170, the flare stack 174, the containers 142, 143, and/or other equipment. Accordingly, the FP system 212 may perform fluid cleaning, reconditioning, and mixing operations. The MPD system 213 may include the RCD 138, the power unit 137, the choke manifold 152, and/or other equipment. The DFC system 214 may comprise the pump units 144, the drilling fluid container 142, the bell nipple 139, and/or other equipment collectively operable to pump and circulate the drilling fluid at the wellsite surface and downhole. The DSR system 215 may include the top drive 116 and/or the rotary table and kelly. The CPC system 216 may comprise the choke manifold 156, the ported adapter 136, and/or other equipment, and the WC system 217 may comprise the BOP stack 130, the power unit 137, and a BOP control station for controlling the power unit 137. The PS system 218 may be or comprise the power supply system 178. The PS system 218 may comprise various sources of electrical power operable to actuator or otherwise power the well construction equipment of the well construction system 100, including the well construction equipment of the well construction subsystems 211-217. The PS system 218 may also include various means for transferring and/or distributing electrical power and fuel to the well construction equipment and between various pieces of equipment of the PS system 218, including electrical power conductors, electrical connectors, electrical relays, fluid conductors, fluid connectors, and fluid valves, among other examples. The sources of electrical power may include electric generators, electrical energy storage devices (e.g., batteries, capacitors, etc.), fuel storage devices, and a remote electrical power grid, among other examples. Each of the well construction subsystems 211-218 may further comprise various communication equipment (e.g., modems, network interface cards, etc.) and communication conductors (e.g., cables), communicatively connecting the equipment (e.g., sensors and/or actuators) of each subsystem 211-218 with the central controller 192 and the control workstation 197. Although the well construction equipment listed above and shown in FIG. 1 is associated with certain wellsite subsystems 211-218, such associations are merely examples that are not intended to limit or prevent such well construction equipment from being associated with two or more wellsite subsystems 211-218 and/or different wellsite subsystems 211-218.

The rig control system 200 may include various local controllers 221-228, each operable to control various well construction equipment of a corresponding subsystem 211-218 and/or an individual piece of well construction equipment of a corresponding subsystem 211-218. Each well construction subsystem 211-218 includes various well construction equipment comprising corresponding actuators 241-248 for performing operations of the well construction system 100. Each subsystem 211-218 may include various sensors 231-238 operable to output or otherwise facilitate sensor data (i.e., sensor signals and/or sensor measurements) indicative of operational status of the well construction equipment of each subsystem 211-218. Each local controller 221-228 may output control data (i.e., control commands and/or control signals) to one or more actuators 241-248 to cause the actuators 241-248 to perform corresponding actions of a piece of equipment or subsystem 211-218. Each local controller 221-228 may receive the sensor data output by one or more sensors 231-238 indicative of operational status of an actuator or another portion of a piece of equipment of a corresponding subsystem 211-218.

The sensors 231-238 may include sensors utilized for operation of the various subsystems 211-218 of the well construction system 100. For example, the sensors 231-238 may include cameras, position sensors, speed sensors, acceleration sensors, pressure sensors, force sensors, temperature sensors, flow rate sensors, vibration sensors, electrical current sensors, electrical voltage sensors, resistance sensors, gesture detection sensors or devices, voice actuated or recognition devices or sensors, chemical sensors, exhaust sensors, and/or other examples. The sensor data may include signals, information, and/or measurements indicative of equipment operational status (e.g., on or off, percent load, up or down, set or released, etc.), drilling parameters (e.g., depth, hook load, torque, etc.), auxiliary parameters (e.g., vibration data of a pump), flow rate, temperature, operational speed, position, and pressure, among other examples. The acquired sensor data may include or be associated with a timestamp (e.g., date and/or time) indicative of when the sensor data was acquired. The sensor data may also or instead be aligned with a depth or other drilling parameter.

Each subsystem 211-218 may further include one or more corresponding local human-machine interfaces (HMIs) 251-258 usable by rig personnel (e.g., equipment maintenance personnel) to configure, monitor, and control corresponding well construction equipment of that subsystem 211-218. Each local HMI 251-258 may be installed in association with a corresponding piece of well construction equipment or subsystem 211-218 and communicatively connected with a corresponding local controller 221-228, sensors 231-238, and/or actuators 241-248. Each HMI 251-258 may be operable for entering or otherwise communicating control data to the corresponding local controller 221-228 by the rig personnel for controlling corresponding well construction equipment and/or subsystem 211-218. Although the local controllers 221-228, the sensors 231-238, the actuators 241-248, and the local HMIs 251-258 are each represented by a single block, it is to be understood that each subsystem 211-218 may comprise a plurality of local controllers 221-228, sensors 231-238, actuators 241-248, and locals HMIs 251-258.

The local controllers 221-228, the sensors 231-238, the actuators 241-248, and the local HMIs 251-258 may be communicatively connected with the central controller 192. For example, the sensors 231-238, the actuators 241-248, and the local HMIs 251-258 of the corresponding subsystems 211-218 may be communicatively connected with the local controllers 221-228 via local communication networks (e.g., field buses) (not shown) and the central controller 192 may be communicatively connected with the local controllers 221-228 via a rig communication network 210 (e.g., a data bus, a field bus, a wide-area-network (WAN), a local-area-network (LAN), etc.). The sensor data output by the sensors 231-238 of the subsystems 211-218 may be received and processed by the local controllers 221-228 and/or the central controller 192. Similarly, control data output by the central controller 192 and/or the local controllers 221-228 may be communicated to the various actuators 241-248 of the subsystems 211-218, perhaps pursuant to predetermined programming, such as to facilitate well construction operations and/or other operations described herein. Although the central controller 192 is shown as a single device (i.e., a discrete hardware component), it is to be understood that the central controller 192 may be or comprise a plurality of equipment controllers and/or other electronic devices collectively operable to monitor and control operations (i.e., computational processes or methods) of the well construction system 100. The central controller 192 may be located within or form a portion of a control center 190, however a portion of the central controller 192 may instead be external to the control center 190.

The sensors 231-238 and actuators 241-248 may be monitored and/or controlled by corresponding local controllers 221-228 and/or the central controller 192. For example, the central controller 192 may be operable to receive the sensor data from the sensors 231-238 of the subsystems 211-218 in real-time, and to output real-time control data directly to the actuators 241-248 of the subsystems 211-218 based on the received sensor data. However, certain operations of the actuators 241-248 of each subsystem 211-218 may be controlled by a corresponding local controller 221-228, which may control the actuators 241-248 based on the sensor data received from the sensors 231-238 of the corresponding subsystem 211-218 and/or based on control data received from the central controller 192.

The rig control system 200 may be a tiered control system, wherein control of the subsystems 211-218 of the well construction system 100 may be provided via a first tier of the local controllers 221-228 and a second tier of the central controller 192. The central controller 192 may facilitate control of one or more of the subsystems 211-218 at the level of each individual subsystem 211-218. For example, in the FP system 212, the sensor data may be fed into the local controller 242, which may respond to control the actuators 232. However, for control operations that involve multiple subsystems 211-218, the control may be coordinated through the central controller 192 operable to coordinate control of well construction equipment of two, three, four, or more (each) of the subsystems 211-218. For example, coordinated control operations may include the control of downhole pressure during tripping. The downhole pressure may be affected by the DFC system 214 (e.g., pump rate), the MPD system 213 (e.g., position of the choke 152), and the TH system 211 (e.g., tripping speed). Thus, when it is intended to maintain certain downhole pressure during tripping, the central controller 192 may output control data to two or more of the participating subsystems 211-218.

The central controller 192, the local controllers 221-228, and/or other controllers or processing devices (referred to hereinafter as “equipment controllers”) of the rig control system 200 may each or collectively be operable to receive and store machine-readable and executable program code instructions (e.g., computer program code, algorithms, programmed processes or operations, etc.) on a memory device (e.g., a memory chip) and then execute the program code instructions to run, operate, or perform a control process for monitoring and/or controlling the well construction equipment of the well construction system 100.

The control workstation 197 may be utilized to monitor, configure, control, and/or otherwise operate well construction equipment of one or more of the subsystems 211-218 of the well construction system 100 by the rig personnel. The well construction equipment may be monitored and/or controlled or operated at least partially manually by the rig personnel (e.g., a driller) via the control workstation 197. The control workstation 197 may be communicatively connected with the central controller 192 and/or the local controllers 221-228 via the rig communication network 210 and operable to receive the sensor data from the sensors 231-238 and transmit control data to the central controller 192 and/or the local controllers 221-228 to control the actuators 241-248. Accordingly, the control workstation 197 may be utilized by the rig personnel to monitor, configure, and control the actuators 241-248 and other portions of the subsystems 211-218 via the central controller 192 and/or local controllers 221-228.

During manual or semi-automatic operation, the rig personnel may operate as a mechanization manager of the rig control system 200 by manually coordinating operations of various well construction equipment, such as to achieve an intended operational status (or drilling state) of the well construction operations, including tripping in or drilling at an intended rate of penetration (ROP). The control process of each local controller 221-228 may facilitate a lower (e.g., basic) level of control within the rig control system 200 to operate a corresponding piece of well construction equipment or a plurality of pieces of well construction equipment of a corresponding subsystem 211-218. Such control process may facilitate, for example, starting, stopping, and setting or maintaining an operating speed of a piece of well construction equipment. During manual operation of the well construction system 100, the rig personnel manually controls the individual pieces of well construction equipment to achieve the intended operational status of each piece of well construction equipment.

The central controller 192 may run (i.e., execute) a central control process 260 (i.e., a coordinated control process) and each local controller 221-228 may run a corresponding local control process (not shown). The central control process 260 of the central controller 192 may operate as a mechanization manager of the rig control system 200, coordinating operations between well construction equipment within the same subsystem 211-218 and between well construction equipment of different subsystems 211-218. Each local controller 221-228 may run a local control processes to coordinate operations between well construction equipment within the same subsystem 211-218.

The control process 260 of the central controller 192 may output control data directly to the actuators 241-248 to control the well construction operations. The control process 260 may also or instead output control data to the control process of one or more local controllers 221-228, wherein each local control process of the local controllers 221-228 may then output control data to the actuators 241-248 of the corresponding subsystem 211-218 to control a portion of the well construction operations performed by that subsystem 211-218. Thus, the control processes of equipment controllers (e.g., central controller 192 and/or local controllers 221-228) of the rig control system 200 individually and collectively perform monitoring and control operations described herein, including monitoring and controlling well construction operations. The program code instructions forming the basis for the central control process 260 and the local control processes described herein may comprise rules (e.g., algorithms) based on the laws of physics for drilling and other well construction operations.

Each control process 260 being run by an equipment controller of the rig control system 200 may receive and process (i.e., analyze) sensor data from the sensors 231-238 according to the program code instructions, and generate control data (i.e., control signals or information) to operate or otherwise control the actuators 241-248 of the well construction equipment. Equipment controllers within the scope of the present disclosure can include, for example, programmable logic controllers (PLCs), industrial computers (IPCs), personal computers (PCs), soft PLCs, variable frequency drives (VFDs) and/or other controllers or processing devices operable to store and execute program code instructions, receive sensor data, and output control data to cause operation of the well construction equipment based on the program code instructions, sensor data, and/or control data.

The central controller 192 may also or instead be operable to receive and store machine-readable and executable program code instructions on a memory device and then execute such program code instructions to run, operate, or perform a monitoring and notification process 262 operable to monitor (i.e., determine, calculate, etc.) operational status (i.e., operational parameters) and/or operational health (i.e., condition) of the various well construction equipment of the well construction system 100 and then notify personnel (e.g., rig personnel, maintenance personnel, etc.) of the operational status and operational health. For example, the monitoring and notification process 262 may be operable to receive and then analyze or otherwise process operational data (e.g., sensor data output by the sensors 231-238), determine the operational status of the well construction equipment based on the operational data, and then output operational status information indicative of the operational status of the well construction equipment to a video output device for viewing by the personnel. The monitoring and notification process 262 may be further operable to receive and then analyze or otherwise process the operational data, determine the operational health of the well construction equipment based on the operational data, and then output operational health information indicative of the operational health of the well construction equipment to a video output device for viewing by the personnel. One or more of the local controllers 221-228 may also execute program code instructions to execute a corresponding monitoring and notification process 262 to monitor the operational status and/or the operational health of the well construction equipment of a corresponding subsystem 211-218. The local controllers 221-228 may then transmit operational status information indicative of the operational status and the operational health information indicative of the operational health to the central controller 192, which may then output the operational status information and the operational health information to a video output device for viewing by the personnel.

The operational status information output by the monitoring and notification process 262 may be or comprise a plurality of operational status indicators, wherein each indicator defines, describes, or is otherwise indicative of operational status of the well construction equipment with respect to a different operational status category. The monitoring and notification process 262 may be operable determine and output the operational status information in terms of plurality of different operational status indicators to permit personnel (e.g., rig personnel, maintenance personnel, etc.) to evaluate operational status of the well construction equipment based on the different operational status categories. Each operational status indicator may be indicative of, for example, operational state and/or operational measurements associated with a piece of well construction equipment.

The operational health information output by the monitoring and notification process 262 may be or comprise a plurality of operational health indicators, wherein each indicator defines, describes, or is otherwise indicative of operational health of the well construction equipment with respect to a different operational health category. The monitoring and notification process 262 may be operable determine and output the operational health information in terms of plurality of different operational health indicators to permit the personnel to evaluate operational health of the well construction equipment based on the different operational health categories. Each operational health indicator may be indicative of operational health of the well construction equipment with respect to a corresponding operational health category. Each operational health category may be or comprise a different aspect, dimension, type, or criteria of operational health of the well construction equipment. Each operational health category may consider or be associated with different category of operational data indicative of operational health of the well construction equipment. Thus, each operational health indicator may be based on a different category of operational data indicative of operational health of the well construction equipment, and thus may be or comprise an independent indicator of operational health of the well construction equipment.

The monitoring and notification process 262 executed by the central controller 192 and/or the local controllers 221-228 may be operable to output (e.g., transmit, push, etc.) the operational status information and the operational health information to the control workstation 197 to be displayed to rig personnel (e.g., the driller) via the video output device 196. The monitoring and notification process 262 may also or instead be operable to output the operational status information and the operational health information to one or more local and/or remote monitoring devices 264, 266, 268 to be displayed to maintenance personnel. Each monitoring device 264, 266, 268 may comprise a video output device operable to display the operational status information and the operational health information to the maintenance personnel. For example, the monitoring and notification process 262 may be operable to output the operational status information and the operational health information to a local monitoring device 264 to be viewed by rig maintenance personnel at the wellsite, who can then perform maintenance operations. The monitoring and notification process 262 may be operable to output the operational status information and the operational health information to remote monitoring devices 266, 268 to be displayed to remote maintenance personnel (e.g., technical support personnel, maintenance planners, maintenance supervisors, etc.) located off the wellsite, at a remote location from the wellsite. The monitoring devices 264, 266, 268 may be or comprise mobile or non-mobile monitoring devices, such as PCs (e.g., desktops, laptops, tablet computers, etc.), personal digital assistants, smartphones, servers, internet appliances, and/or other types of computing devices. The monitoring devices 264, 266, 268 may be mobile monitoring devices carried by the maintenance personnel or stationary monitoring devices accessible by the maintenance personnel. One or more of the remote monitoring devices 266, 268, such as the remote monitoring device 268, may be located at a remote center 270 (e.g., a monitoring center, a technical support center, etc.). The local monitoring device 264 may be communicatively connected with the central controller 192 and/or the local controllers 221-228 via the rig communication network 210. The remote monitoring devices 266, 268 may be communicatively connected with the central controller 192 and/or the local controllers 221-228 via a WAN 272 (e.g., an Ethernet connection, a digital subscriber line (DSL), a telephone line, a coaxial cable, a cellular telephone system, a satellite communication system, etc.) and the rig communication network 210.

Each operational status indicator and operational health indicator may be displayed on a video output device of one or more of the control workstation 197 and the monitoring devices 264, 266, 268. An operational status indicator may be or comprise, for example, a number (e.g., a sensor measurement) and/or a color indicative of operational status of the well construction equipment. Displaying operational status information in terms of different operational status indicators can permit personnel to quickly and easily ascertain a more complete understanding (i.e., assessment) of general and specific operational status of the well construction equipment. An operational health indicator may be or comprise, for example, a number (e.g., a numerical health index, numerical ranking, numerical level, etc.) and/or a color indicative of operational health of the well construction equipment. Displaying operational health information in terms of different operational health indicators can permit personnel to quickly and easily ascertain a more complete understanding (i.e., assessment) of general and specific operational health of the well construction equipment. Displaying operational health information in terms of different operational health indicators can permit maintenance personnel to prioritize maintenance operations, such as by permitting planning or performance of maintenance operations to improve operational health of the well construction equipment with respect to operational health categories that are not operationally healthy.

One or more of the central controller 192 and the monitoring devices 264, 266, 268 may be communicatively connected with a plurality (i.e., a fleet) of remote well construction systems 274. Each of the remote well construction systems 274 may be similar to the well construction system 100, comprising structure and/or mode of operation of the well construction system 100. One or more of the central controller 192 and the monitoring devices 264, 266, 268 may be communicatively connected with a central controller and/or local controllers of each remote well construction system 274 via the WAN 272 and a corresponding rig communication network.

Similarly to the well construction system 100, each remote well construction system 274 may comprise a central controller operable to run, operate, or perform a corresponding monitoring and notification process 262 operable to monitor operational status and/or operational health of well construction equipment of that well construction system 274, and then notify personnel of the operational status and operational health. For example, the monitoring and notification process 262 performed at each remote well construction system 274 may be operable to receive and then analyze or otherwise process operational data, determine the operational status of the well construction equipment based on the operational data, and then output operational status information (e.g., operational status indicators) indicative of the operational status of the well construction equipment to one or more of the central controller 192 and the monitoring devices 264, 266, 268. The monitoring and notification process 262 performed at each remote well construction system 274 may be further operable to receive and then analyze or otherwise process the operational data, determine the operational health of the well construction equipment based on the operational data, and then output operational health information (e.g., operational health indicators) indicative of the operational health of the well construction equipment to one or more of the central controller 192 and the monitoring devices 264, 266, 268. The operational status information and the operational health information may be displayed on a video output device of one or more of the workstation 197 and the monitoring devices 264, 266, 268 for viewing by the personnel. Accordingly, one or more of the central controller 192 and the monitoring devices 264, 266, 268 may be operable to receive the operational status information and the operational health information generated at each well construction system 100, 274, and then display the operational status information and the operational health information on a video output device.

Each monitoring device 264, 266, 268 may be operable to run, operate, or perform a corresponding monitoring and notification process 262 operable to monitor operational status and/or operational health of well construction equipment of the well construction systems 100, 274, and then notify personnel of the operational status and operational health. For example, the monitoring and notification process 262 of a monitoring device 264, 266, 268 may be operable to receive and then analyze or otherwise process operational data from each well construction system 100, 274, determine the operational status of the well construction equipment of each well construction system 100, 274 based on the operational data, and then output operational status information (e.g., operational status indicators) indicative of the operational status of the well construction equipment for display on a video output device of that monitoring device 264, 266, 268 for viewing by the personnel. The monitoring and notification process 262 of a monitoring device 264, 266, 268 may be operable to receive and then analyze or otherwise process operational data from each well construction system 100, 274, determine the operational health of the well construction equipment of each well construction system 100, 274 based on the operational data, and then output operational health information (e.g., operational health indicators) indicative of the operational health of the well construction equipment for display on a video output device of that monitoring device 264, 266, 268 for viewing by the personnel. Accordingly, one or more of the monitoring devices 264, 266, 268 may be operable to generate the operational status information and the operational health information based on the operational data received from the well construction systems 100, 274, and then display the operational status information and the operational health information on a video output device.

One or more portions of the rig control system 200 of the well construction systems 100, 274 may form at least a portion of a monitoring system 280 for monitoring operational status and operational health of the well construction equipment of the well construction systems 100, 274. For example, the monitoring system 280 may comprise the central controllers 192 and/or the local controllers 221-228 of the well construction systems 100, 274. The monitoring system 280 may comprise the sensors 231-241 of the well construction systems 100, 274. The monitoring system 280 may comprise the monitoring devices 264, 266, 268. The monitoring system 280 may comprise the WAN 272 communicatively connecting the well construction systems 100, 274 and the monitoring devices 264, 266, 268. One or more portions of the monitoring system 280 may be operable to execute the monitoring and notification process 262 to monitor the operational status and operational health of the well construction equipment of the well construction systems 100, 274.

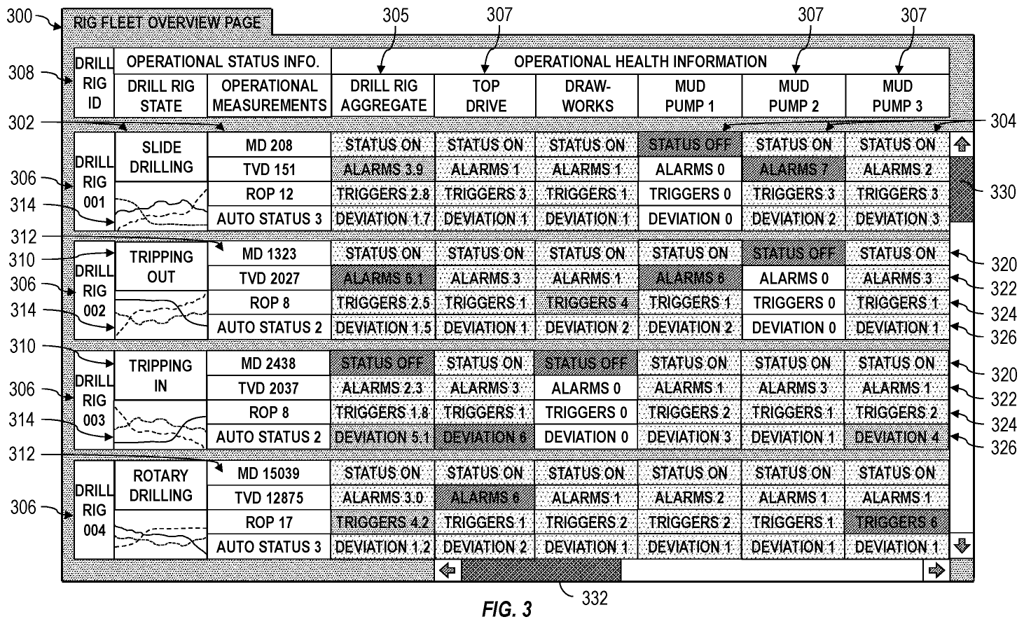

FIG. 3 is a portion of an example overview page 300 (i.e., display screen or tab) displaying operational status information 302 and operational health information 304 for predetermined pieces of well construction equipment (referred to hereinafter as “equipment units”) of a plurality (i.e., a fleet) of well construction systems 100, 274 (referred to hereinafter as “drill rigs”) shown in FIGS. 1 and 2. The operational status information 302 and operational health information 304 may be determined by the monitoring and notification process 262 executed by one or more portions of the monitoring system 280 shown in FIG. 2 based on operational data from each well construction system 100, 274, and then output for display on a video output device. The overview page 300 may be displayed to personnel (e.g., rig personnel, maintenance personnel, etc.) on a video output device of the control workstation 197 and/or one or more of the monitoring devices 264, 266, 268 shown in FIG. 2. The overview page 300 may be or comprise a landing page or screen for viewing operational status and health of a plurality of drill rigs. Accordingly, the following description refers to FIGS. 1-3, collectively.

The operational status information 302 may comprise a plurality of different operational status indicators 310, 312, 314 each being indicative of operational status of a drill rig and/or an equipment unit of the drill rig. The operational health information 304 may comprise a plurality of different operational health indicators 320, 322, 324, 326, each being indicative of operational health of a drill rig and/or an equipment unit of that drill rig. The operational status indicators 310, 312, 314 and the operational health indicators 320, 322, 324, 326 may be arranged or otherwise displayed in a group (e.g., a row) 306 comprising operational status indicators 310, 312, 314 and operational health indicators 320, 322, 324, 326 associated with the same drill rig or equipment units of the same drill rig. The overview page 300 may display a plurality of groups 306 of operational status indicators 310, 312, 314 and operational health indicators 320, 322, 324, 326, wherein each group comprises operational status indicators 310, 312, 314 and operational health indicators 320, 322, 324, 326 associated with a different drill rig. The overview page 300 may display a plurality of rows 305, 307 of operational health indicators 320, 322, 324, 326, wherein the row 305 comprises operational health indicators 320, 322, 324, 326 associated with each drill rig, and the rows 307 comprise operational health indicators 320, 322, 324, 326 associated with each equipment unit of that drill rig. The overview page 300 may also display a scrolling feature 330, which when operated by personnel, may cause the overview page 300 to scroll vertically, thereby permitting other groups 306 of operational status indicators 310, 312, 314 and operational health indicators 320, 322, 324, 326 for other drill rigs to be displayed on the overview page 300.

The overview page 300 may also display a plurality of headings 308 (i.e., captions) in association (e.g., above) the groups 306. Some of the headings 308 may identify or separate the operational status information from the operational health information. Some of the headings 308 may identify or describe the operational status indicators 310, 312, 314 and/or operational health indicators 320, 322, 324, 326. Some of the headings 308 may identify, describe, or otherwise associate the operational status indicators 310, 312, 314 and/or operational health indicators 320, 322, 324, 326 with a corresponding equipment unit. In other words, some of the headings 308 may identify which operational status indicators 310, 312, 314 and/or operational health indicators 320, 322, 324, 326 describe which equipment unit. The overview page 300 may also display a scrolling feature 332, which when operated by personnel, may cause a portion of the overview page 300 to scroll horizontally, thereby permitting other operational health indicators 320, 322, 324, 326 for other equipment units to be displayed on the overview page 300.

Each operational status indicator 310 may comprise, for example, a description of the current state (i.e., stage or phase of well construction operations) of a corresponding drill rig. Each operational status indicator 312 may comprise, for example, operational measurements indicative of progress of the well construction operations of a corresponding drill rig and/or equipment units of that drill rig. The operational status indicators 312 may include, for example, measured depth (MD) of the wellbore, total vertical depth (TVD) of the wellbore, ROP through the subterranean formation, and a set automation level of the drill rigs (e.g., manual, semi-automatic, or automatic). Each operational status indicator 314 may comprise, for example, graphs or other visual indicators indicative of, for example, state of a corresponding drill rig and/or progress of well construction operations over a predetermined span of time (e.g., past one hour, past 12 hours, past 24 hours, etc.) for that drill rig. The operational data utilized by one or more portions of the monitoring system 280 to determine the operational status indicators 310, 312, 314 may thus be or comprise measurement-while-drilling (MWD) data from the BHA 124, travelling block position data from the drawworks 118, and/or control data from the control process 260 of the central controller 192. Each operational status indicator 310, 312, 314 may be displayed in association with a title (i.e., caption) describing or otherwise indicative of the operational status category to which the operational status indicator 310, 312, 314 corresponds. Each operational status indicator 310, 312, 314 and the associated title may be displayed within or otherwise in association with a corresponding software icon (e.g., a shape, a box, a window, etc.).

Each operational health indicator 320, 322, 324, 326 may be or comprise a visual indicator, such as a number or a color indicative of operational health of a corresponding equipment unit with respect to a corresponding operational health category. A numerical operational health indicator may range, for example, between one and ten, with a low number being indicative of an operationally healthy equipment unit, and a high number being indicative of an operationally unhealthy equipment unit. A color based operational health indicator may include, for example, green, yellow, and red colors, with the green color being indicative of an operationally healthy equipment unit, the yellow color being indicative of a mildly operationally unhealthy equipment unit, and the red color being indicative of an operationally unhealthy equipment unit. Each operational health indicator 320, 322, 324, 326 may be displayed in association with a title (i.e., a caption) describing or otherwise indicative of the operational health category to which the operational health indicator 320, 322, 324, 326 corresponds. Each operational health indicator 320, 322, 324, 326 and the associated title may be displayed within or otherwise in association with a corresponding software icon (e.g., a shape, a box, a window, etc.).

The operational health information 304 shown in row 305 may comprise aggregate (i.e., cumulative) operational health indicators 320, 322, 324, 326 indicative of overall operational health of the drill rig with respect to a corresponding operational health category. The aggregate operational health indicators 320, 322, 324, 326 may be or comprise a sum or an average of the operational health indicators 320, 322, 324, 326 for the individual equipment units shown in rows 307. The aggregate operational health indicators 320, 322, 324, 326 may instead be or comprise the highest (i.e., the most unhealthy) of the operational health indicators 320, 322, 324, 326 of the individual equipment units shown in rows 307.

Each drill rig and equipment unit may be turned on and actively operating (i.e., online) or be turned off or otherwise not operating (i.e., offline) because of various circumstances (e.g., the drill rig is being moved, a state of the drill rig not requiring operation of an equipment unit, scheduled maintenance, operational failure, etc.). The monitoring and notification process 262 executed by one or more portions of the monitoring system 280 may monitor (i.e., determine) the active status of a drill rig and/or an equipment unit. Each operational health indicator 320 may be indicative of an active status of a drill rig and/or an equipment unit. For example, when a drill rig and/or an equipment unit is not active, the operational health indicator 320 may comprise the word “OFF” and/or a red color. When a drill rig and/or an equipment unit is active, the operational health indicator 320 may comprise the word “ON” and/or a green color. The operational data utilized by the monitoring system 280 to determine the active status indicators 320 may thus be or comprise control data for controlling the drill rig and/or equipment units output by the control process 260 of the central controller 192 and/or sensor data output by various sensors of the drill rig and/or equipment units.

Each equipment unit may have a plurality of abnormal operation alarms, each operable to automatically trigger or set off when a corresponding operational parameter exceeds one or more predetermined thresholds of normal (or abnormal) or otherwise intended operation of that equipment unit, thereby indicating abnormal operation of the equipment unit. Each equipment unit may have a plurality of portions (i.e., components), each portion associated with a predetermined threshold of normal operation. Each equipment unit may have a plurality of alarms, each associated with a different portion of the equipment unit. Each equipment unit may have one or more alarms for each of its portions, which may include, for example, a motor, a transmission, a pump, and/or a brake. Each portion of the equipment unit may have an alarm for different operational parameters associated with that portion. Each portion of the equipment unit may have alarms for one or more operational parameters, which may include, for example, temperature, pressure, flow, speed, level, and/or position. Each operational parameter of each portion of the equipment unit may have a corresponding threshold of normal (or abnormal) operation. Each alarm may be triggered when a corresponding threshold of normal operation is exceeded.

The monitoring and notification process 262 executed by one or more portions of the monitoring system 280 may monitor active status of the abnormal operation alarms. The monitoring and notification process 262 may then generate an operational health indicator 322 indicative of states of abnormal operation alarms associated with that equipment unit. The monitoring and notification process 262 may also or instead monitor operational parameters (and thus operational health) associated with an equipment unit with respect to thresholds of normal operation for that equipment unit. The monitoring and notification process 262 may then generate an operational health indicator indicative of operational health (e.g., level of abnormal operation) of each portion of that equipment unit with respect to corresponding threshold or thresholds of normal operation for that portion of the equipment unit. The monitoring and notification process 262 may then determine an operational health indicator for each of the other portions of the equipment unit and determine an operational health indicator 322 (e.g., a color, an index, etc.) for the equipment unit based on the operational health indicator or indicators associated with each portion of the equipment unit. The operational health indicator 322 for each equipment unit may be or comprise an aggregate (i.e., a cumulative) operational health indicator 322, such as comprising a sum or an average of the operational health indicators of the individual portions of that equipment unit. The operational health indicator 322 for each equipment unit may instead be or comprise the highest (i.e., the most unhealthy) of the operational health indicators of the individual portions of that equipment unit. The monitoring and notification process 262 may then display the operational health indicator 322 for the equipment unit on the overview page 300.

For example, an abnormal operation alarm may be set for operating temperature of a motor for rotating a drum of the drawworks 118. A manufacturer recommended maximum operating temperature threshold for the motor may be 95 degrees Celsius (° C.). Abnormal operation alarms for the motor may be set to, for example, 80° C. and 95° C. Thus, when the motor is operated at 80° C. or less, the operational health indicator associated with the motor may have a value between, for example, one and three, and/or a green color. When the motor is operated at a temperature between 80° C. and 95° C., a first alarm may be triggered and the operational health indicator associated with the motor may have a value between, for example, three and six, and/or a yellow color. When the motor is operated at a temperature above 95° C., a second alarm may be triggered and the operational health indicator associated with the motor may have a value between, for example, six and ten, and/or a red color. The monitoring and notification process 262 may then determine an operational health indicator for each of the other portions of the drawworks 118 and determine an aggregate operational health indicator 322 for the drawworks 118 based on the operational health indicators associated with each portion of the drawworks 118. The monitoring and notification process 262 may then display the aggregate operational health indicator 322 for the drawworks 118 on the overview page 300. The operational data utilized by the monitoring system 280 to determine the abnormal operation health indicators 322 may thus be or comprise predetermined thresholds of normal (or abnormal) operation for the equipment unit and/or portions of the equipment unit, abnormal operation alarm data output by the central controller 192, and/or sensor data output by various sensors of the drill rig, the equipment units, and/or portions of the equipment unit.

An equipment unit may have a plurality of operational triggers that are triggered (i.e., implemented or executed) when certain measured operational parameters are reached or exceeded during the course of normal operation of the equipment unit. Each operational trigger may be indicative of a threshold of operational measurements within a normal operating range of the equipment unit. Each threshold of the operational measurements may be set or selected by personnel based on their experience with the equipment unit and/or based on historical operational measurements indicative of operational status of the equipment unit. Each threshold may be or comprise a pre-defined level of an operational parameter that personnel experienced while operating the equipment unit or an anomaly limit. Each operational trigger may be recorded by the central controller 192 and/or a database accessible by the monitoring system 280. The monitoring and notification process 262 executed by one or more portions of the monitoring system 280 may monitor deviation from the predetermined thresholds of operational performance of the equipment unit and trigger corresponding operational triggers. The operational health indicator 324 may thus be indicative of states of operational triggers associated with an equipment unit. For example, an operational trigger may be set for operating temperature of a motor for rotating a drum of a drawworks 118. The temperature may be measured and recorded for a predetermined period of time (e.g., a week, a month, etc.) during which the temperature does not exceed 70° C. (or some other predetermined temperature). An operational trigger may be set to, for example, 75° C., which when activated, may alert maintenance personnel to check operation of the motor even though such temperature is within the normal operating temperature range. Thus, when the motor is operated at less than 75° C., the operational health indicator 324 may have a value between, for example, one and three, and/or a green color. However, when the motor is operated at 75° C. or more, the operational trigger may be activated and the operational health indicator 324 may have a value between, for example, three and six, and/or a yellow color. The operational data utilized by the monitoring system 280 to determine the operational health indicators 324 may thus be or comprise predetermined thresholds of operational performance and/or sensor data output by various sensors of the drill rig and/or equipment units.

A mathematical (i.e., analytical) model of the equipment unit may be generated by a computer, and then the computer (or another computer) may run simulated operations of the mathematical model to calculate operational performance that can be expected from the actual equipment unit during actual operations of the equipment unit. The mathematical model may thus be considered a digital twin of the equipment unit that can be used as a basis for evaluating various operational performance of the equipment unit during operations. The operational health indicator 326 may thus be indicative of amount of deviation of measured operational performance facilitated by the sensors 231-238 from expected operational performance determined based on a mathematical model of an equipment unit. For example, a mathematical model of a pump unit 144 may be generated and its operations may be simulated by a computer (e.g., the central controller). The monitoring and notification process 262 executed by one or more portions of the monitoring system 280 may then compare measured operational performance to expected (i.e., simulated) operational performance. The measured and expected operational performances that can be compared may be indicative of, for example, drilling fluid flow, operating pressure, operating speed, motor temperature, electrical power consumption, and amplitude of vibrations. For example, when the measured and expected operational performances differ by less than 5% (or some other predetermined amount), the operational health indicator 326 may have a value between, for example, one and three, and/or a green color. When the measured and expected operational performances differ by 5% to 10% (for example), the operational health indicator 326 may have a value between, for example, three and six, and/or a yellow color. When the measured and expected operational performances differ by more than 10% (for example), the operational health indicator 326 may have a value between, for example, six and ten, and/or a red color. The operational data utilized by the monitoring system 280 to determine the operational health indicators 324 may thus be or comprise the expected operational performance generated based on the mathematical model and/or sensor data (i.e., the measured operational performance) output by various sensors of the drill rig and/or equipment units.

Each software icon containing an operational status or health indicator 310, 312, 314, 320, 322, 324, 326 may operate as a digital link to information utilized to determine the operational status or health indicators 310, 312, 314, 320, 322, 324, 326. Each software icon may be pressed, clicked, selected, or otherwise operated via an input device and/or via finger contact with a video output device (i.e., a touchscreen) by personnel to operate the digital link associated with that software icon. Operating a digital link of a software icon may cause, for example, another page to be displayed on the video output device instead of the overview page 300. The new page may display detailed information that may permit the personnel to further evaluate the operational status and/or operational health of a drill rig and/or an equipment unit based on such detailed information.

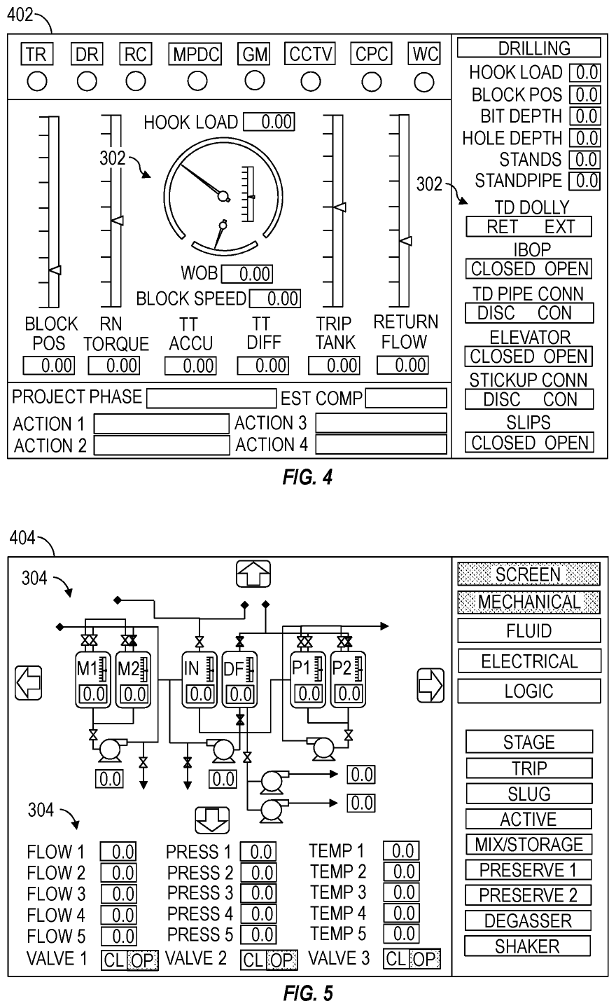

FIG. 4 is an example display page (i.e., screen or window) 402 displaying various operational parameters of a drill rig and/or individual equipment units (e.g., top drive, drawworks, and mud pump units) associated with the operational status information 302. The display page 402 may be displayed on a video output device when a digital link of a software icon associated with one or more of the operational status indicators 310, 312, 314 is operated.

FIG. 5 is an example display page 404 displaying various operational parameters of equipment units (e.g., mud pump units and mud tanks) associated with the operational health information 304. The display page 404 displays operational measurements and thus active status of the equipment units. The display page 404 may be displayed on a video output device when a digital link of a software icon associated with an operational status indicator 320 is operated.

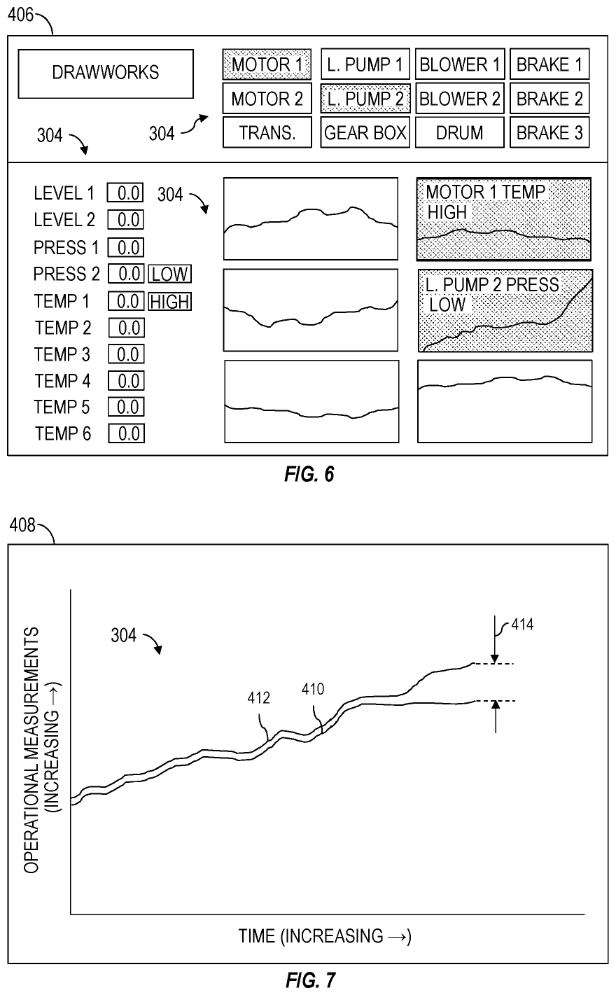

FIG. 6 is an example display page 406 displaying operational health information 304 indicative of operational health of an equipment unit (e.g., a drawworks) and the various portions (e.g., motors, lube pumps, transmissions, gear boxes, blowers, drums, brakes, etc.) of that equipment unit. The displayed operational health information 304 may be indicative of measured operational parameters of the portions of the equipment unit. The displayed operational health information 304 may comprise information based on which the operational health indicator 322 may be determined. For example, the operational health information 304 may be indicative of operational health of each portion of the equipment unit with respect to a threshold of normal operation of that portion of the equipment unit. The displayed operational health information 304 may also or instead be indicative of states of abnormal operation alarms and/or states of operational triggers associated with the equipment units. The display page 406 may be displayed on a video output device when a digital link of a software icon associated with an operational health indicator 322 is operated. The display page 406 may also be displayed on a video output device when a digital link of a software icon associated with an operational trigger state indicator 324 is operated.

FIG. 7 is an example display page 408 displaying expected (i.e., simulated) operational performance (e.g., temperature, flow, pressure, etc.) 410 determined based on a mathematical model of an equipment unit and measured operational performance 412 facilitated by sensors associated with the equipment unit. The monitoring and notification process 262 may monitor the difference 414 between the expected operational performance 410 and the measured operational performance 412. The display page 408 may be displayed on a video output device when a digital link of a software icon associated with a mathematical model deviation indicator 326 is operated.

As described above and shown in FIGS. 1-7, systems (e.g., the monitoring system 280) and methods (e.g., the above-described operational health monitoring operations) according to one or more aspects of the present disclosure may be utilized or otherwise implemented in association with a well construction system (e.g., the well construction system 100) at an oil and gas wellsite, such as for constructing a wellbore to obtain hydrocarbons (e.g., oil and/or gas) from a subterranean formation. However, the systems and methods of the present disclosure may be utilized or otherwise implemented in association with other automated systems in the oil and gas industry and other industries. For example, the systems and methods of the present disclosure may be implemented in association with wellsite systems for performing fracturing, cementing, acidizing, chemical injecting, and/or water jet cutting operations, among other examples. The systems and methods of the present disclosure may also be implemented in association with mining sites, building construction sites, and/or other work sites where automated machines or equipment are utilized.

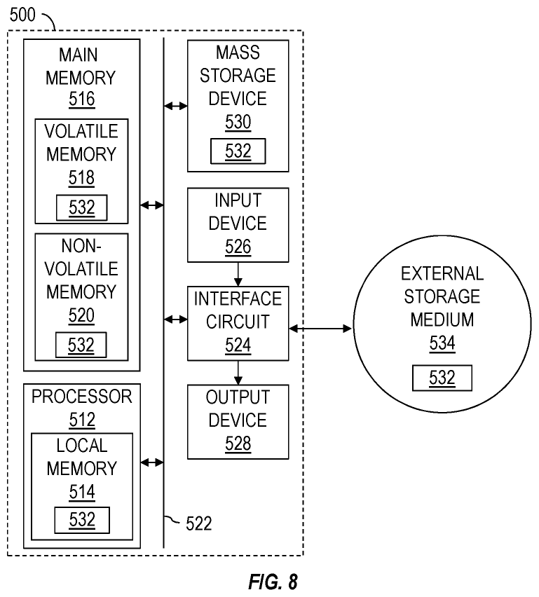

FIG. 8 is a schematic view of at least a portion of an example implementation of a processing device (or system) 500 according to one or more aspects of the present disclosure. The processing device 500 may be or form at least a portion of one or more equipment controllers and/or other electronic devices shown in (or otherwise associated with) one or more of FIGS. 1-7. Accordingly, the following description refers to FIGS. 1-8, collectively.

The processing device 500 may be or comprise, for example, one or more processors, controllers, special-purpose computing devices, PCs (e.g., desktop, laptop, and/or tablet computers), personal digital assistants, smartphones, IPCs, PLCs, servers, internet appliances, and/or other types of computing devices. The processing device 500 may be or form at least a portion of the control and/or monitoring systems 200, 280, including the central controller 192, the local controllers 221-228, the control workstation 197, and the monitoring devices 264, 266, 268. Although it is possible that the entirety of the processing device 500 is implemented within one device, it is also contemplated that one or more components or functions of the processing device 500 may be implemented across multiple devices, some or an entirety of which may be at the wellsite and/or remote from the wellsite.

The processing device 500 may comprise a processor 512, such as a general-purpose programmable processor. The processor 512 may comprise a local memory 514, and may execute machine-readable and executable program code instructions 532 (i.e., computer program code) present in the local memory 514 and/or another memory device. The processor 512 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Examples of the processor 512 include one or more INTEL microprocessors, microcontrollers from the ARM and/or PICO families of microcontrollers, embedded soft/hard processors in one or more FPGAs.

The processor 512 may execute, among other things, the program code instructions 532 and/or other instructions and/or programs to implement the example methods and/or operations described herein. For example, the program code instructions 532, when executed by the processor 512 of the processing device 500, may cause the processor 512 to receive and process (e.g., compare) sensor data (e.g., sensor measurements). The program code instructions 532, when executed by the processor 512 of the processing device 500, may also or instead cause the processor 512 to output control data (i.e., control commands) to cause one or more portions or pieces of well construction equipment of a well construction system to perform the example methods and/or operations described herein.

The processor 512 may be in communication with a main memory 516, such as may include a volatile memory 518 and a non-volatile memory 520, perhaps via a bus 522 and/or other communication means. The volatile memory 518 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 520 may be, comprise, or be implemented by read-only memory, flash memory, and/or other types of memory devices. One or more memory controllers (not shown) may control access to the volatile memory 518 and/or non-volatile memory 520.

The processing device 500 may also comprise an interface circuit 524, which is in communication with the processor 512, such as via the bus 522. The interface circuit 524 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 524 may comprise a graphics driver card. The interface circuit 524 may comprise a communication device, such as a modem or network interface card to facilitate exchange of data with external computing devices via a WAN (e.g., an Ethernet connection, a DSL, a telephone line, a coaxial cable, a cellular telephone system, a satellite communication system, etc.).

The processing device 500 may be in communication with various sensors, video cameras, actuators, processing devices, equipment controllers, and other devices of the well construction system via the interface circuit 524. The interface circuit 524 can facilitate communications between the processing device 500 and one or more devices by utilizing one or more communication protocols, such as an Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 526 may also be connected to the interface circuit 524. The input devices 526 may permit a human user to enter the program code instructions 532, which may be or comprise control data, operational parameters, operational set-points, a well construction plan, and/or a database of operational sequences. The program code instructions 532 may further comprise modeling or predictive routines, equations, algorithms, processes, applications, and/or other programs operable to perform example methods and/or operations described herein. The input devices 526 may be, comprise, or be implemented by a keyboard, a mouse, a joystick, a touchscreen, a track-pad, a trackball, an isopoint, and/or a voice recognition system, among other examples. One or more output devices 528 may also be connected to the interface circuit 524. The output devices 528 may permit for visualization or other sensory perception of various data, such as sensor data, status data, and/or other example data. The output devices 528 may be, comprise, or be implemented by video output devices (e.g., an LCD, an LED display, a CRT display, a touchscreen, etc.), printers, and/or speakers, among other examples. The one or more input devices 526 and the one or more output devices 528 connected to the interface circuit 524 may, at least in part, facilitate the communication devices described herein.

The processing device 500 may comprise a mass storage device 530 for storing data and program code instructions 532. The mass storage device 530 may be connected to the processor 512, such as via the bus 522. The mass storage device 530 may be or comprise a tangible, non-transitory storage medium, such as a floppy disk drive, a hard disk drive, a compact disk (CD) drive, and/or digital versatile disk (DVD) drive, among other examples. The processing device 500 may be communicatively connected with an external storage medium 534 via the interface circuit 524. The external storage medium 534 may be or comprise a removable storage medium (e.g., a CD or DVD), such as may be operable to store data and program code instructions 532.

As described above, the program code instructions 532 may be stored in the mass storage device 530, the main memory 516, the local memory 514, and/or the removable storage medium 534. Thus, the processing device 500 may be implemented in accordance with hardware (perhaps implemented in one or more chips including an integrated circuit, such as an ASIC), or may be implemented as software or firmware for execution by the processor 512. In the case of firmware or software, the implementation may be provided as a computer program product including a non-transitory, computer-readable medium or storage structure embodying computer program code instructions 532 (i.e., software or firmware) thereon for execution by the processor 512. The program code instructions 532 may include program instructions or computer program code that, when executed by the processor 512, may perform and/or cause performance of example methods, processes, and/or operations described herein.

The present disclosure is further directed to example methods (e.g., operations and/or processes) of performing wellsite operations described herein. The methods may be performed by utilizing or otherwise in conjunction with at least a portion of one or more implementations of one or more instances of the apparatus shown in one or more of FIGS. 1-8, and/or otherwise within the scope of the present disclosure. The methods may be caused to be performed, at least partially, by a processing device, such as the processing device 500 executing program code instructions according to one or more aspects of the present disclosure. Thus, the present disclosure is also directed to a non-transitory, computer-readable medium comprising computer program code that, when executed by the processing device, may cause such processing device to perform the example methods described herein. The methods may also or instead be caused to be performed, at least partially, by a human operator (e.g., rig personnel, maintenance personnel, etc.) utilizing one or more instances of the apparatus shown in one or more of FIGS. 1-8, and/or otherwise within the scope of the present disclosure. Thus, the following description of example methods refer to apparatus shown in one or more of FIGS. 1-8. However, the methods may also be performed in conjunction with implementations of apparatus other than those depicted in FIGS. 1-8 that are also within the scope of the present disclosure. Accordingly, the following description refers to FIGS. 1-8, collectively.

An example method according to one or more aspects of the present disclosure may comprise commencing operation of a monitoring system 280 for monitoring a plurality of drill rigs 100, 274, wherein each drill rig 100, 274 comprises a plurality of equipment units collectively operable to perform well construction operations to construct a well 102. Commencing operation of the monitoring system 200 may cause the monitoring system 280 to receive operational data from each of the drill rigs 100, 274, determine operational status 302 of each drill rig 100, 274 based at least partially on the operational data, determine a plurality of operational health indicators 320, 322, 324, 326 for each equipment unit of each drill rig 100, 274 based at least partially on the operational data, and display the operational status 302 for each drill rig and the operational health indicators 320, 322, 324, 326 for each equipment unit of each drill rig 100, 274 on a single page 300 on a video output device 196. The operational status 302 of each drill rig 100, 274 may be indicative of stage 310 of the well construction operations, measured depth 312 of the well, total vertical depth 312 of the well, and/or rate of penetration 312.

Each operational health indicator 320, 322, 324, 326 may be or comprises a number indicative of the operational health of a corresponding equipment unit. Each operational health indicator 320, 322, 324, 326 may also or instead be or comprises a color indicative of operational health of a corresponding equipment unit. Each operational health indicator 320, 322, 324, 326 may be indicative of operational health of a corresponding equipment unit with respect to a different operational health category. One of the operational health indicators 320 may be indicative of active status of a corresponding equipment unit. One of the operational health indicators 322 may be indicative of states of abnormal operation alarms associated with a corresponding equipment unit. Another one of the operational health indicators 324 may be indicative of states of operational triggers associated with a corresponding equipment unit, wherein each operational trigger may be indicative of a predetermined threshold of operational performance of a corresponding equipment unit, and wherein each predetermined threshold of operational performance may be within a normal operating range of a corresponding equipment unit. Still another one of the operational health indicators 326 may be indicative of an amount of deviation of operational performance of a corresponding equipment unit from expected operational performance of that equipment unit determined based on a mathematical model of that equipment unit.

In view of the entirety of the present disclosure, including the figures and the claims, a person having ordinary skill in the art will readily recognize that the present disclosure introduces a monitoring system for monitoring a plurality of drill rigs, wherein each drill rig comprises a plurality of equipment units collectively operable to perform well construction operations to construct a well, wherein the monitoring system comprises a processor and a memory storing an executable computer program code, and wherein the monitoring system is operable to: receive operational data from each of the drill rigs; determine operational status of each drill rig based at least partially on the operational data; determine a plurality of operational health indicators for each equipment unit of each drill rig based at least partially on the operational data, wherein each operational health indicator is indicative of operational health of a corresponding equipment unit with respect to a different operational health category; and display the operational status for each drill rig and the operational health indicators for each equipment unit of each drill rig on a single page on a video output device.

The operational status of each drill rig may be indicative of a stage of the well construction operations, measured depth of the well, total vertical depth of the well, and/or rate of penetration by a drill bit.

Each operational health indicator may be or comprise a number indicative of the operational health of a corresponding equipment unit.

Each operational health indicator may be or comprise a color indicative of operational health of a corresponding equipment unit.

One of the operational health indicators may be indicative of an active status of a corresponding equipment unit.

One of the operational health indicators may be an aggregate of operational health of portions of that equipment unit, and the operational health of each portion of the equipment unit may be determined with respect to a threshold of normal operation of that portion of the equipment unit.

One of the operational health indicators may be indicative of operational health of a corresponding equipment unit with respect to a threshold of normal operation of that equipment unit.

One of the operational health indicators may be indicative of states of operational triggers associated with a corresponding equipment unit, each operational trigger may be indicative of a predetermined threshold of operational performance of a corresponding equipment unit, and each predetermined threshold of operational performance may be within a normal operating range of a corresponding equipment unit.

One of the operational health indicators may be indicative of an amount of deviation of measured operational performance of a corresponding equipment unit from expected operational performance of that equipment unit, and the deviation amount may be determined based on a mathematical model of that equipment unit.

The equipment units may comprise a top drive, a mud pump, and a drawworks.

The present disclosure also introduces a monitoring system for monitoring a plurality of drill rigs, wherein each drill rig comprises a plurality of equipment units collectively operable to perform well construction operations to construct a well, wherein the monitoring system comprises a processor and a memory storing an executable computer program code, and wherein the monitoring system is operable to: receive operational data from each of the drill rigs; determine a plurality of operational health indicators for each equipment unit of each drill rig based at least partially on the operational data, wherein a first one of the operational health indicators is indicative of an active status of a corresponding equipment unit, and wherein a second one of the operational health indicators is indicative of operational health of a corresponding equipment unit with respect to a threshold of normal operation of that equipment unit; and display the operational health indicators for each equipment unit of each drill rig on a single page on a video output device.

Each operational health indicator may be or comprise a number indicative of the operational health of a corresponding equipment unit.

Each operational health indicator may be or comprise a color indicative of operational health of a corresponding equipment unit.

Another one of the operational health indicators may be indicative of states of operational triggers associated with a corresponding equipment unit, each operational trigger may be indicative of a predetermined threshold of operational performance of a corresponding equipment unit, and each predetermined threshold of operational performance may be within a normal operating range of a corresponding equipment unit.

Another one of the operational health indicators may be indicative of an amount of deviation of measured operational performance of a corresponding equipment unit from expected operational performance of that equipment unit, and the deviation amount may be determined based on a mathematical model of that equipment unit.

The present disclosure also introduces a method comprising commencing operation of a monitoring system for monitoring a plurality of drill rigs, wherein each drill rig comprises a plurality of equipment units collectively operable to perform well construction operations to construct a well, and wherein commencing operation of the monitoring system causes the monitoring system to: receive operational data from each of the drill rigs; determine operational status of each drill rig based at least partially on the operational data; determine a plurality of operational health indicators for each equipment unit of each drill rig based at least partially on the operational data, wherein each operational health indicator is indicative of operational health of a corresponding equipment unit with respect to a different operational health category; and display the operational status for each drill rig and the operational health indicators for each equipment unit of each drill rig on a single page on a video output device.

The operational status of each drill rig may be indicative of one or more of a stage of the well construction operations, measured depth of the well, total vertical depth of the well, and rate of penetration by a drill bit.

One of the operational health indicators may be an aggregate of operational health of portions of that equipment unit, and the operational health of each portion of the equipment unit may be determined with respect to a threshold of normal operation of that portion of the equipment unit.

One of the operational health indicators may be indicative of states of operational triggers associated with a corresponding equipment unit, each operational trigger may be indicative of a predetermined threshold of operational performance of a corresponding equipment unit, and each predetermined threshold of operational performance may be within a normal operating range of a corresponding equipment unit.

One of the operational health indicators may be indicative of an amount of deviation of operational performance of a corresponding equipment unit from expected operational performance of that equipment unit, and the deviation amount may be determined based on a mathematical model of that equipment unit.

The foregoing outlines features of several implementations so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the implementations introduced herein. A person having ordinary skill in the art should also realize that such equivalent constructions do not depart from the scope of the present disclosure, and that they may make various changes, substitutions and alterations herein without departing from the scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. An apparatus comprising:
a monitoring system for monitoring a plurality of drill rigs, wherein each drill rig comprises a plurality of equipment units collectively operable to perform well construction operations to construct a well, wherein the monitoring system comprises a processor and a memory storing an executable computer program code, and wherein the monitoring system is operable to:
receive operational data from each of the drill rigs;
determine operational status of each drill rig based at least partially on the operational data;
determine a plurality of operational health indicators for each equipment unit of each drill rig based at least partially on the operational data, wherein each operational health indicator is indicative of operational health of a corresponding equipment unit with respect to a different operational health category; and
display the operational status for each drill rig and the operational health indicators for each equipment unit of each drill rig on a single page on a video output device.

2. The apparatus of claim 1 wherein the operational status of each drill rig is indicative of one or more of a stage of the well construction operations, measured depth of the well, total vertical depth of the well, and rate of penetration by a drill bit.

3. The apparatus of claim 1 wherein each operational health indicator is or comprises a number indicative of the operational health of a corresponding equipment unit.

4. The apparatus of claim 1 wherein each operational health indicator is or comprises a color indicative of operational health of a corresponding equipment unit.

5. The apparatus of claim 1 wherein one of the operational health indicators is indicative of an active status of a corresponding equipment unit.

6. The method of claim 1 wherein one of the operational health indicators is an aggregate of operational health of portions of that equipment unit, and wherein the operational health of each portion of the equipment unit is determined with respect to a threshold of normal operation of that portion of the equipment unit.

7. The apparatus of claim 1 wherein one of the operational health indicators is indicative of operational health of a corresponding equipment unit with respect to a threshold of normal operation of that equipment unit.

8. The apparatus of claim 1 wherein:
one of the operational health indicators is indicative of states of operational triggers associated with a corresponding equipment unit;
each operational trigger is indicative of a predetermined threshold of operational performance of a corresponding equipment unit; and
each predetermined threshold of operational performance is within a normal operating range of a corresponding equipment unit.

9. The apparatus of claim 1 wherein one of the operational health indicators is indicative of an amount of deviation of measured operational performance of a corresponding equipment unit from expected operational performance of that equipment unit, and wherein the deviation amount is determined based on a mathematical model of that equipment unit.

10. The apparatus of claim 1 wherein the equipment units comprise a top drive, a mud pump, and a drawworks.

11. An apparatus comprising:
a monitoring system for monitoring a plurality of drill rigs, wherein each drill rig comprises a plurality of equipment units collectively operable to perform well construction operations to construct a well, wherein the monitoring system comprises a processor and a memory storing an executable computer program code, and wherein the monitoring system is operable to:
receive operational data from each of the drill rigs;
determine a plurality of operational health indicators for each equipment unit of each drill rig based at least partially on the operational data, wherein a first one of the operational health indicators is indicative of an active status of a corresponding equipment unit, and wherein a second one of the operational health indicators is indicative of operational health of a corresponding equipment unit with respect to a threshold of normal operation of that equipment unit; and
display the operational health indicators for each equipment unit of each drill rig on a single page on a video output device.

12. The apparatus of claim 11 wherein each operational health indicator is or comprises a number indicative of the operational health of a corresponding equipment unit.

13. The apparatus of claim 11 wherein each operational health indicator is or comprises a color indicative of operational health of a corresponding equipment unit.

14. The apparatus of claim 11 wherein:
a third one of the operational health indicators is indicative of states of operational triggers associated with a corresponding equipment unit;
each operational trigger is indicative of a predetermined threshold of operational performance of a corresponding equipment unit; and
each predetermined threshold of operational performance is within a normal operating range of a corresponding equipment unit.

15. The apparatus of claim 11 wherein a third one of the operational health indicators is indicative of an amount of deviation of measured operational performance of a corresponding equipment unit from expected operational performance of that equipment unit, and wherein the deviation amount is determined based on a mathematical model of that equipment unit.

16. A method comprising:
commencing operation of a monitoring system for monitoring a plurality of drill rigs, wherein each drill rig comprises a plurality of equipment units collectively operable to perform well construction operations to construct a well, and wherein commencing operation of the monitoring system causes the monitoring system to:
receive operational data from each of the drill rigs;
determine operational status of each drill rig based at least partially on the operational data;
determine a plurality of operational health indicators for each equipment unit of each drill rig based at least partially on the operational data, wherein each operational health indicator is indicative of operational health of a corresponding equipment unit with respect to a different operational health category; and
display the operational status for each drill rig and the operational health indicators for each equipment unit of each drill rig on a single page on a video output device.

17. The method of claim 16 wherein the operational status of each drill rig is indicative of one or more of a stage of the well construction operations, measured depth of the well, total vertical depth of the well, and rate of penetration by a drill bit.

18. The method of claim 16 wherein one of the operational health indicators is an aggregate of operational health of portions of that equipment unit, and wherein the operational health of each portion of the equipment unit is determined with respect to a threshold of normal operation of that portion of the equipment unit.

19. The method of claim 16 wherein:
one of the operational health indicators is indicative of states of operational triggers associated with a corresponding equipment unit;
each operational trigger is indicative of a predetermined threshold of operational performance of a corresponding equipment unit; and
each predetermined threshold of operational performance is within a normal operating range of a corresponding equipment unit.

20. The method of claim 16 wherein one of the operational health indicators is indicative of an amount of deviation of operational performance of a corresponding equipment unit from expected operational performance of that equipment unit, and wherein the deviation amount is determined based on a mathematical model of that equipment unit.
